(19) United States
(12) Patent Application Publication
(10) Pub. No.: US 2016/0027119 A1
(43) Pub. Date: Jan. 28, 2016

(54) HEALTH OR PHARMACY PLAN BENEFIT TESTING

(71) Applicants: Madhu KOLACHINA, Irving, TX (US); Niraj Krishna, Flower Mound, TX (US); Patrick Randle, San Antonio, TX (US)

(72) Inventors: Madhu KOLACHINA, Irving, TX (US); Niraj Krishna, Flower Mound, TX (US); Patrick Randle, San Antonio, TX (US)

(21) Appl. No.: 14/339,725

(22) Filed: Jul. 24, 2014

(51) Int. Cl. G06Q 40/08

(52) U.S. Cl. CPC G06Q 40/08; G06Q 50/22

(57) ABSTRACT

A benefit plan testing system and process are disclosed. The system and process provide for receiving a benefit plan specification, the benefit plan specification including a plurality of documents including indications of requirements of a benefit plan, consolidating the benefit plan specification into a benefit matrix, generating a set of test claims based in part on the benefit matrix, and adjudicating the set of test claims under the benefit plan.

### FIELD OF THE DISCLOSURE

The disclosure relates generally to the field of health benefits, and more particularly to a system and method for testing a health or pharmacy benefit plan.

### BACKGROUND OF THE DISCLOSURE

Health insures offer various “plans” that provide covered services to members of the plan. The “plan” is often referred to as a benefit plan, health benefit, health benefit plan, pharmacy benefit plan, or the like. The benefit plan specifies a variety of items regarding the covered services, such as, for example, type of service, location for services, reimbursement amount, patient co-insurance, deductibles, or the like. In the case of a pharmacy benefit plan, the plan may specify the types of prescriptions covered, class of prescriptions (e.g., generic, formulary, non-formulary, or the like), co-insurance amounts, or the like.

For a patient to make use of a benefit plan, a claim is made to the insurer. The member or the entity providing the health or pharmacy service can submit the claim to the insurer. Submitted claims are adjudicated against the benefit plan to determine if the claim is valid. Specifically, the claim is adjudicated to determine if (i) the member for whom the claim seeks coverage is enrolled in the plan and (ii) the services or prescriptions the claim seeks coverage for are eligible for coverage under the plan. Based on the results of the claim adjudication process, the benefits claim is approved or not.

As will be appreciated, adjudication of a benefit claims is dependent upon the numerous definitions and specifications of the corresponding benefit plan. As such, ensuring that benefit claims are processed as expected is an important task in implementing and maintaining benefit plans and benefit claim systems. In particular, it is important to “test” a benefit plan to ensure that claims submitted under the plan are processed (e.g., approved or not) in an expected manner.

One of the problems with benefit testing, and specifically testing pharmacy benefits, is that it may often yield very inefficient results due to improper clinical coverage. More specifically, the pharmacy benefit is often tested with a limited list of drugs. This limited list may not allow for proper testing of the benefit plan due to factors such as duplicity of items in the limited list of drugs, list of drugs containing infrequently prescribed drugs but missing out popularly prescribed used drugs. All these factors can impact the test results negatively.

An alternative may be testing the entire drug list specified in the plan. However, this may be impractical and/or unfeasible as the list of covered prescriptions is usually very large (e.g. 150,000 prescriptions, or more).

It is with respect to these and other considerations that the present improvements are desired.

### SUMMARY

In view of the forgoing, a system and method for testing a benefit plan is disclosed.

An exemplary method implemented by a benefit plan testing system is provided. The method may include receiving a benefit plan specification, the benefit plan specification including a plurality of documents including indications of requirements of a benefit plan, consolidating the benefit plan specification into a benefit matrix, generating a set of test claims based in part on the benefit matrix, and adjudicating the set of test claims under the benefit plan.

Another exemplary method implemented by a benefit plan testing system is provided. The method may include receiving a benefit plan specification, the benefit plan specification including a plurality of documents including indications of requirements of a benefit plan, generating a prescription test list including an indication of a plurality of prescriptions, consolidating the benefit plan specification into a benefit matrix, generating a set of test claims based in part on the benefit matrix and the prescription test list, and adjudicating the set of test claims under the benefit plan.

An exemplary embodiment of a machine-readable storage medium is also provided. The machine-readable storage medium may include instructions that when executed by a computing device, cause the computing device to receive a benefit plan specification, the benefit plan specification including a plurality of documents including indications of requirements of a benefit plan, consolidate the benefit plan specification into a benefit matrix, generate a set of test claims based in part on the benefit matrix, and adjudicate the set of test claims under the benefit plan.

### BRIEF DESCRIPTION OF THE DRAWINGS

By way of example, specific embodiments of the disclosed device will now be described, with reference to the accompanying drawings, in which:

FIG. 1 is a block diagram illustrating a benefit plan testing system in accordance with the present disclosure.

FIGS. 2-3 are block diagrams illustrating portions of the system shown in FIG. 1 is greater detail, all arranged in accordance with the present disclosure.

FIGS. 4A-4G are flow diagrams illustrating exemplary methods for testing a benefit plan in accordance with the present disclosure.

FIGS. 5-8 are flow diagrams illustrating exemplary methods for generating a perceptions test lists in accordance with the present disclosure.

FIG. 9 is a block diagram of an example benefit plan specification and corresponding benefit matrix in accordance with the present disclosure.

FIGS. 10-11 are block diagrams illustrating portions of the system shown in FIG. 1 in greater detail, all arranged in accordance with the present disclosure.

### DETAILED DESCRIPTION

Systems and methods for the testing of benefit plans in accordance with the present disclosure will now be described more fully hereinafter with reference to the accompanying drawings. In general, the present disclosure provides systems and methods to test a benefit plan, and particularly, for testing the behavior of a benefit claim submitted under the plan.

It is to be appreciated that the present disclosure can be used to test both new benefit plans (e.g., before and after initial integration of the benefit plan into a claim processing system) and existing plans (e.g., after maintenance of the claims processing system).

In some examples, the present disclosure provides for the testing of a benefit plan claim processing system to (i) to ensure benefit claims submitted under a particular benefit plan are submitted by (or on behalf of) a member of the benefit plan; and (ii) identify defaults and/or defects in the claim.

It is important to note, however, that the disclosed systems and methods may be embodied in many different forms and should not be construed as limited to the embodiments set forth herein. Rather, these embodiments are provided so that this disclosure will be thorough and complete, and will fully convey the scope of the claims. In the drawings, like numbers refer to like elements throughout.

Furthermore, it is important to note, that although the following examples describe a benefit plan testing system in the context of testing a pharmacy benefit, examples are not limited in this context. In particular, the present disclosure may be applied to testing a health benefit plan that does not include prescription coverage.

Additionally, in some examples, the present disclosure can be implemented to test multiple different benefit plans for a single insurer. In particular, a single insurer may have multiple different plans that need testing. It is to be appreciated, however, that although the present disclosure discusses testing a single plan for clarity of presentation, multiple plans may be tested, even simultaneously by various embodiments of the present disclosure.

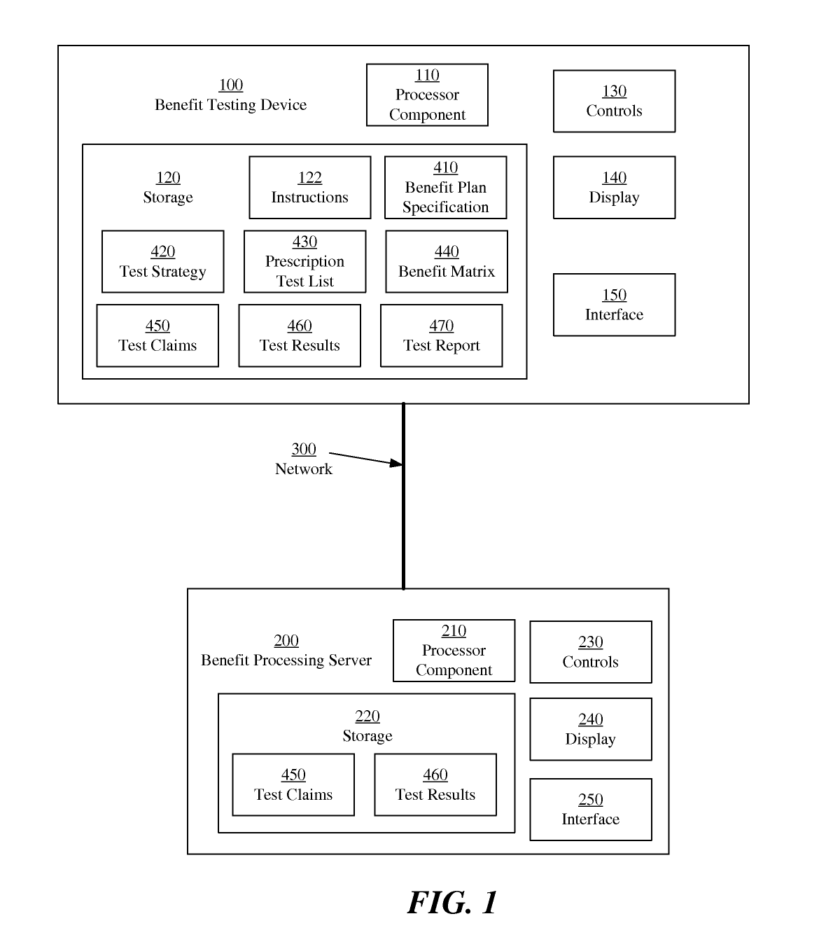

A first exemplary configuration in accordance with the present disclosure is depicted in FIG. 1. The disclosed benefit testing system includes a benefit plan testing device 100 and a benefit claim processing server 200 operably coupled via network connection 300. Each of the device 100 and the server 200 may be any of a variety of types of computing devices. For example, without limitation, the benefit plan testing device 100 and/or the benefit claim processing server 200 may be a server, a desktop computer, a data entry terminal, a laptop computer, a netbook computer, a tablet computer, a smart phone, or the like.

It is important to note, although the device 100 and server 200 are depicted and discussed herein as two separate devices, the device 100 and the server 200 may be a single device. In particular, the features and functionality of the device 100 and the server 200 may be implemented in a single device and provided according to various embodiments of the present disclosure to test a benefit plan as discussed herein.

As depicted, the benefit plan testing device 100 and the benefit claim processing server 200 exchange signals conveying benefit claim test cases and/or benefit claim test results through network 300. However, one of more of the benefit plan testing device 100 and/or the benefit claim processing server 200 may exchange signals unrelated to benefit testing with each other and/or with still other computing devices (not shown) through the network 300 or through another network connection (not shown).

In various examples, the network 300 may be a single network possibly limited to extending within a defined area (e.g., office building, or the like) or other relatively limited area, a combination of connected networks possibly extending a considerable distance, and/or may include the Internet. Thus, the network 300 may be based on any of a variety (or combination) of communications technologies by which signals may be exchanged, including without limitation, wired technologies employing electrically and/or optically conductive cabling, and wireless technologies employing radio frequency, near filed communication, Bluetooth, infrared, or other forms of wireless transmission.

In various embodiments, the benefit plan testing device 100 incorporates one or more of a processor component 110, storage 120, controls 130, a display 140, and an interface 150 to couple the device 100 to the network 300. The storage 120 stores one or more instructions 122, benefit plan specification 410, a test strategy 420, a prescription test list 430, a benefit matrix 440, test claims 450, test results 460, and a test report 470.

In various embodiments, the benefit claim processing server 200 incorporates one or more of a processor component 210, storage 220, controls 230, and an interface 250 to couple the server 200 to the network 300. The storage 220 stores one or more instructions 222, test claims 450, and test results 460.

In the benefit plan testing device 100, the instructions 122 may correspond to a sequence of instructions operative on the processor component 110 to implement logic to perform various functions. In executing the instructions 122, the processor component 110 receives the benefit plan specification 410 including indications of requirements of a benefit plant to be tested. In general, the specification 410 may be embodied as a variety of document (e.g., text files, spreadsheets, xml files, or the like) and may correspond to various documents describing the benefit plan, such as, for example a client requirement document (CRD), a network information (NIF) document, a clinical plan management (CPM) document, a utilization management records document, various addendums, or the like.

Additionally, in executing the instructions 122, the processor component 110 may generate a test plan or test strategy 420 from the specification 410. In general, the test strategy 420 may include various milestones and/or blueprints of the testing process. The various milestones of the test strategy 420 may be used to trigger updates and approval requests from various key stakeholders in the process (explained in greater detail below).

Furthermore, in executing the instructions 122, the processor component 110 may generate the prescription test list 430. The prescription test list is a clinical listing of prescriptions to be used in testing the benefit plan.

Additionally, in executing the instructions 122, the processor component 110 may generate the benefit matrix 440 from the specification 410. The benefit matrix 440 is a single file including indications of the plan requirements consolidated from the various documents of the specification 410.

Furthermore, in executing the instructions 122, the processor component 110 generates the test claims 450 from the benefit matrix 440 and optionally, the prescription test list 430. The test claims 450 are hypothetical claims for benefit under the plan. Each of the hypothetical claims in the test claims 450 includes relevant test data (e.g., hypothetical member name, age, gender, claim details, or the like) necessary for the hypothetical claim to be adjudicated.

Additionally, in executing the instructions 122, the processor component 110 submits the test claims 450 to the benefit claim processing server 200 for adjudication and receives the results of the adjudication (e.g., the test results 460) from the benefit claim processing server 200.

Furthermore, in executing the instructions 122, the processor component 110 generates a test report 470 from the test results 450. In general, the test report 470 is a viewable report that may be provided for various key stakeholders in the testing process.

In the benefit claim processing server 200, the instructions 222 may correspond to a sequence of instructions operative on the processor component 210 to implement logic to perform various functions. In executing the instructions 222, the processor component 210 receives the test claims 450 from the device 100 and adjudicates the test claims as described above. In particular, each of the hypothetical claims in the test claims 450 are submitted for processing under the plan, and a determination is made as to whether the claims should be accepted or rejected. The test results 460 are generated to include indications of the results of this adjudication process and communicated to the device 100.

In various embodiments, each of the processor components 110 and 210 may include any of a wide variety of commercially available processors. Further, one or more of these processor components may include multiple processors, a multi-threaded processor, a multi-core processor (whether the multiple cores coexist on the same or separate dies), and/or a multi-processor architecture of some other variety by which multiple physically separate processors are in some way linked.

In various embodiments, each of the storages 120 and 220 may be based on any of a wide variety of information storage technologies, possibly including volatile technologies requiring the uninterrupted provision of electric power, and possibly including technologies entailing the use of machine-readable storage media that may or may not be removable. Thus, each of these storages may include any of a wide variety of types (or combination of types) of storage device, including without limitation, read-only memory (ROM), random-access memory (RAM), dynamic RAM (DRAM), Double-Data-Rate DRAM (DDR-DRAM), synchronous DRAM (SDRAM), static RAM (SRAM), programmable ROM (PROM), erasable programmable ROM (EPROM), electrically erasable programmable ROM (EEPROM), flash memory, polymer memory (e.g., ferroelectric polymer memory), ovonic memory, phase change or ferroelectric memory, silicon-oxide-nitride-oxide-silicon (SONOS) memory, magnetic or optical cards, one or more individual ferromagnetic disk drives, or a plurality of storage devices organized into one or more arrays (e.g., multiple ferromagnetic disk drives organized into a Redundant Array of Independent Disks array, or RAID array). It should be noted that although each of these storages is depicted as a single block, one or more of these may include multiple storage devices that may be based on differing storage technologies. Thus, for example, one or more of each of these depicted storages may represent a combination of an optical drive or flash memory card reader by which programs and/or data may be stored and conveyed on some form of machine-readable storage media, a ferromagnetic disk drive to store programs and/or data locally for a relatively extended period, and one or more volatile solid state memory devices enabling relatively quick access to programs and/or data (e.g., SRAM or DRAM). It should also be noted that each of these storages may be made up of multiple storage components based on identical storage technology, but which may be maintained separately as a result of specialization in use (e.g., some DRAM devices employed as a main storage while other DRAM devices employed as a distinct frame buffer of a graphics controller).

Furthermore, the storages 120 and 220 may be located within the respective computing devices, or may be external to the respective computing devices. In some examples the storages may be on the network, accessible over the Internet, over a secured network (e.g., VPN, intranet, or the like).

In various embodiments, each of the interfaces 150 and 250 may employ any of a wide variety of signaling technologies enabling computing devices to be coupled to other devices as has been described. Each of these interfaces may include circuitry providing at least some of the requisite functionality to enable such coupling. However, each of these interfaces may also be at least partially implemented with sequences of instructions executed by corresponding ones of the processor components (e.g., to implement a protocol stack or other features). Where electrically and/or optically conductive cabling is employed, these interfaces may employ signaling and/or protocols conforming to any of a variety of industry standards, including without limitation, RS-232C, RS-422, USB, Ethernet (IEEE-802.3) or IEEE-1394. Where the use of wireless signal transmission is entailed, these interfaces may employ signaling and/or protocols conforming to any of a variety of industry standards, including without limitation, IEEE 802.11a, 802.11b, 802.11g, 802.16, 802.20 (commonly referred to as “Mobile Broadband Wireless Access”); Bluetooth; ZigBee; or a cellular radiotelephone service such as GSM with General Packet Radio Service (GSM/GPRS), CDMA/1×RTT, Enhanced Data Rates for Global Evolution (EDGE), Evolution Data Only/Optimized (EV-DO), Evolution For Data and Voice (EV-DV), High Speed Downlink Packet Access (HSDPA), High Speed Uplink Packet Access (HSUPA), 4G LTE, etc.

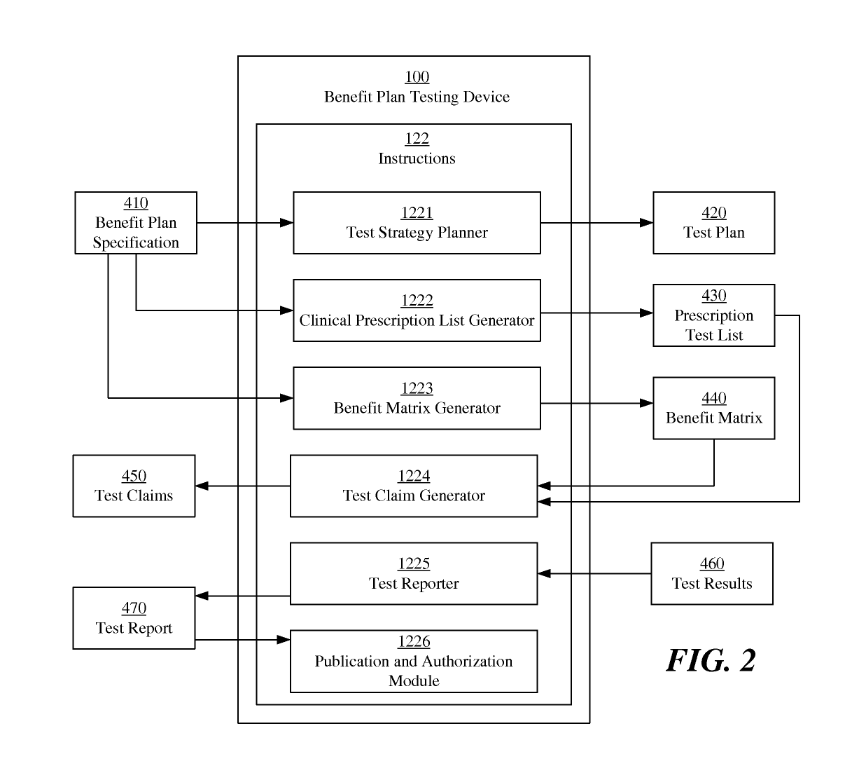

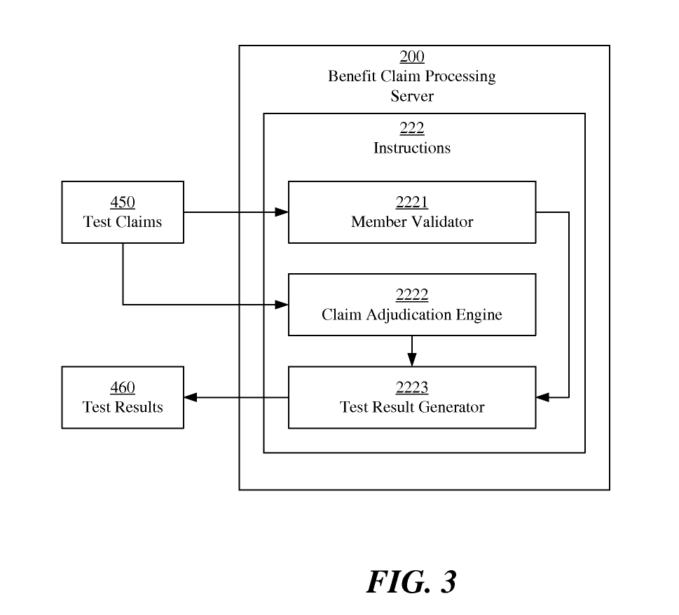

FIGS. 2-3 are each simplified block diagrams of a portion of an embodiment of the system 1000 of FIG. 1. Each of these figures depicts aspects of the operation of testing a benefit plan. More specifically, FIG. 2 depicts aspects of the operation of the benefit plan testing device 100 while FIG. 3 depicts aspects of the operation of the benefit claim processing server 200. Turning more specifically to FIG. 2, the instructions 122 may include a test strategy planner 1221, a clinical prescription list generator 1222, a benefit matrix generator 1223, a test claim generator 1224, a test reporter 1225, and a publication and authorization module 1226. Turning more specifically to FIG. 3, the instructions 222 may include a member validator, a claim adjudication engine, and a test results generator.

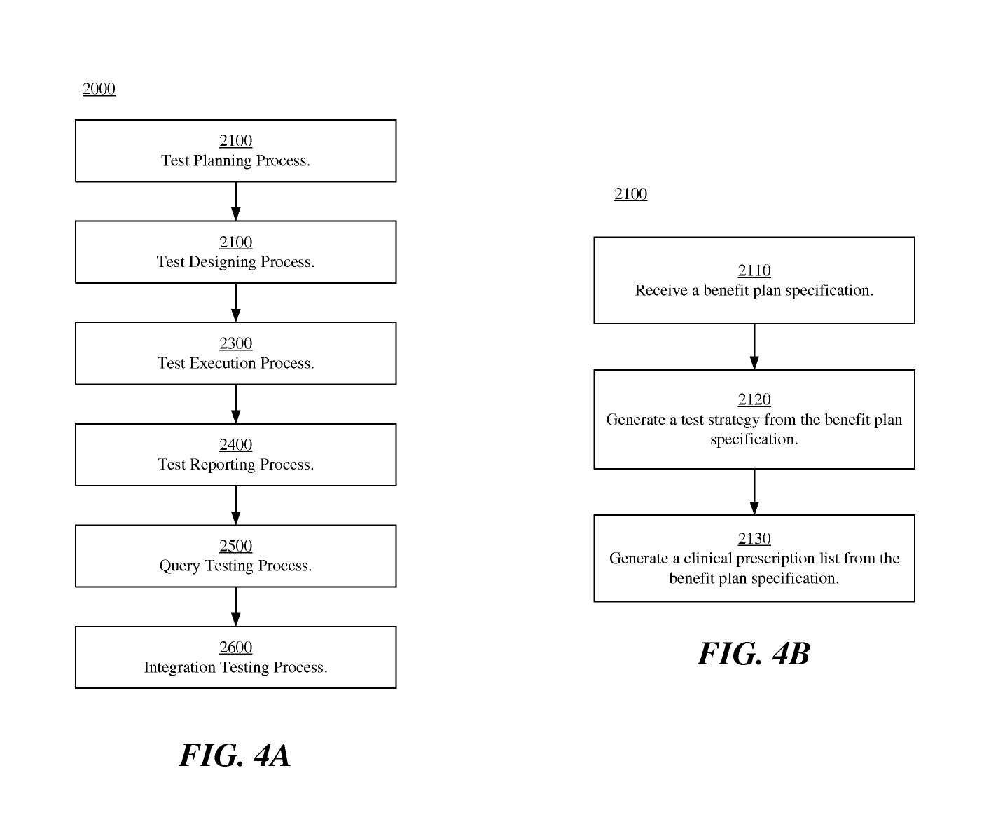

Furthermore, FIG. 4A is a logic flow 2000 for a benefit testing process that may be implemented by the system 1000 of FIG. 1. In general, the benefit testing process reflected in the logic flow 2000 is organized into four sub-processes or logic flows. Particularly, the logic flow 2000 is organized into (i) a test planning logic flow 2100; (ii) a test designing logic flow 2200; (iii) a test execution logic flow 2300; and (iv) a test reporting logic flow 2400. Furthermore, in some examples, the benefit testing process may include optional sub-processes or logic flows, such as, for example, a query testing logic flow 2500 and an integration testing logic flow 2600. Each of these logic flows is depicted in FIGS. 4B-4G, respectively.

The balance of the description of the system 1000 and the logic flow 2000 discusses FIGS. 2-3 and 4A-4E in sections corresponding to these four portions. It is to be appreciated, however, that this is done for clarity of presentation and is not intended to be limiting. Furthermore, these sections discuss both the system 1000 and the logic flow 2000 together. It is to be appreciated that this is also done for convenience and is not intended to be limiting. In particular, the system 1000 may be implemented to perform a benefit testing process that includes more or less operations than reflected in the logic flow 2000 while the logic flow 2000 may be implemented by a system that includes more or less components than the system 1000.

### Test Planning

In general, the “test planning” logic flow 2100 includes operations to receive a benefit plan specification (e.g., specification 410) and/or other material that detail the requirements of a benefit plan and generate a test strategy (e.g., the strategy 420) from the specification. The test strategy may include derivation of clinical drugs lists (e.g., list 430) used to test the benefit plan.

The logic flow 2000 may begin at the test planning logic flow 2100, and in particular, at block 2110. At block 2110 “receive a benefit plan specification”, the test strategy planner 1221 may receive the benefit plan specification 410. In general, an administrator for the benefit plan, the insurer of the benefit plan, or the like may provide the benefit plan specification 410. In some examples, the benefit plan specification 410 is various documents (e.g., spreadsheets, text files, xml files, or the like) that list the requirements (or constraints) of the benefit plan.

In particular, the documents of the benefit plan specification 410 detail “benefits” provided by the plan, including definitions, constraints, limitations, and/or coverage corresponding to the plan. The details of the plan specified in the benefit plan specification 410 are sometimes referred to herein as “requirements.” In some examples, the benefit plan specification 410 is computer readable files including indications of the “benefits” corresponding to the benefit plan. In some examples, the test strategy planner 1221 may receive the benefit plan specification 410 (e.g., from storage 120, over network 300, or the like).

Continuing to block 2120 “generate a test strategy from the benefit plan specification”, the planner 1221 may generate the test strategy 420 based on the specification 410. In some embodiments, the test strategy 420 may include various milestones and/or blueprint for testing the benefit plan associated with the specification 410. For example, the test strategy 420 may identify stakeholders and include a timeline listing various points of the benefit testing process wherein stakeholder updates and/or approval are provided (e.g., test plan approval by stakeholders, test design, test execution, defect resolution, test results review with stakeholders, test results approval by stakeholders, or the like).

In some examples, the test strategy planner 1221 may generate the test strategy 420 based on a “risk” classification of the benefit plan, or a risk classification of the insurer corresponding to the benefit plan. More specifically, the risk associated with a particular benefit plan (of the testing of the plan) may be assessed and the testing process classified into an appropriate risk category. For example, risk categories of “high,” “medium,” and “low” risk may be used. As such, the test strategy planner 1221 may classify a particular benefit plan to be tested into one of the three categories.

With some examples, the test strategy planner 1221 may classify a benefit plan to be tested based on the following parameters:

TABLE 1
Risk Classification Parameters

| | Members | | | | |
|---|---|---|---|---|---|
| Days To Go- | Health | | Plans/Special | Performance | Risk |
| Live | Plan | Commercial | Programs | Guarantees | Category |
| <=15 Days | >100,000 | Coalition <or> | >50/5 | >=1M | High |
| | | >20,000 | | | |
| >15 Days & | >50,000 | <=20,000 | >10/3 | >=500K | Medium |
| <=45 Days | | | | | |
| >45 Days | <=50,000 | <=10,000 | <10/2 | <500K | Low |

As depicted in Table 1, various risk classification parameters may be used. For example, if the time within which the benefit plan has to go live in the insurer's environment (e.g., time till a benefit claim processing server is live) is less than or equal to 15 days and the plans to be tested more than 100,000, the insurer may be categorized as one with high risk. Similarly, other categorizations (e.g., medium, low, or the like) may be determined based on classification as described herein.

The test strategy planner 1221 may take into account this risk categorization when generating the test strategy 420. In particular, some milestones and/or blueprints from the overall testing process might or might not be included in the test strategy 420 based on the risk categorization.

As noted above, in some examples, the benefit plan may be for, or may include pharmacy benefits. As such, the test strategy 420 may include milestones and/or blueprints to test prescriptions covered under the benefit plan. Furthermore, the test strategy 420 may include steps for optimizing prescription samples to test so as to maximize the clinical coverage. As such, the instructions 122 may also include the clinical prescription list generator 1222. In such examples, the logic flow may also include block 2130. At block 2130 “generate a clinical prescription list from the benefit plan specification”, the clinical prescription list generator 1222 may generate the prescriptions test list 430. In general, the clinical prescription list generator 1222 may generate the prescription test list 430 based on one or more of the following approaches: (1) smart grouping approach; (2) statistical approach; (3) most used drugs approach; and/or (4) closed formulary approach.

It is noted, that approaches 1 to 3 are applicable to open formularies. That is, these approaches apply to all drugs that might have to be tested. The fourth approach, however, is specific to closed formulary only. That is, this approach applies only to those plan specific drugs whose information may be retrieved from the benefit plan specification 410.

Furthermore, it is noted the clinical prescription list generator 1222 may use any combination of one or more of these approaches, or other approaches to generate the prescription test list 430. The above listed approached are discussed in greater detail hereafter.

Smart Grouping Approach

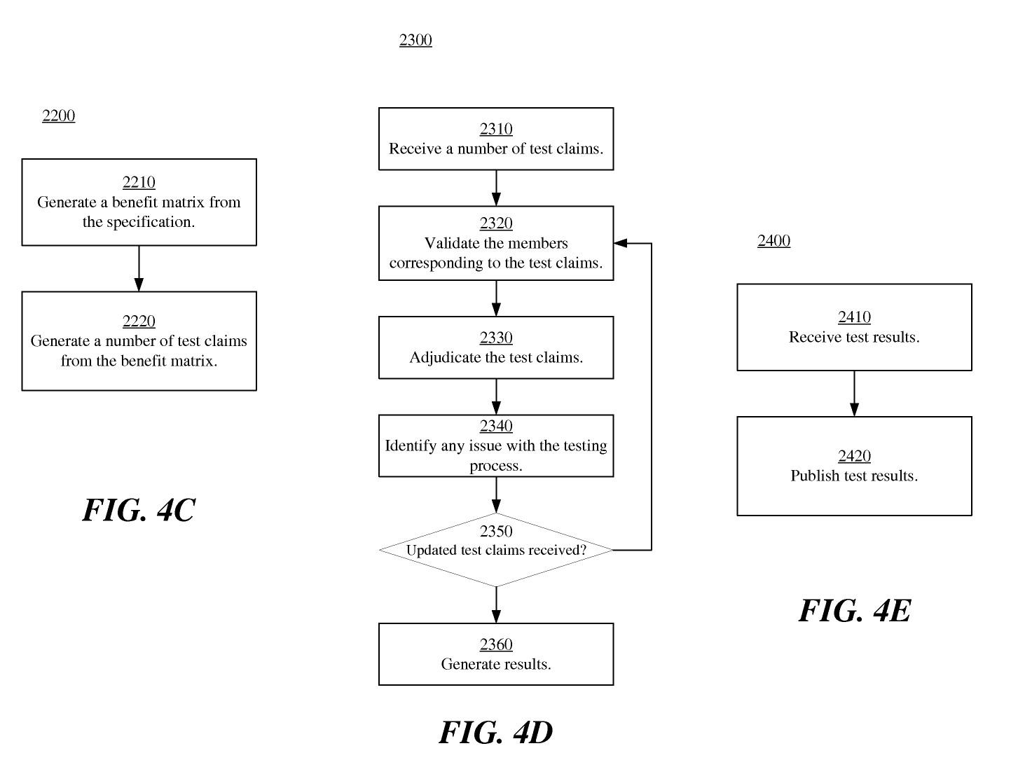

With the smart grouping approach, the generator 1222 reduces the drug list specified in the specification 410 based on one or more filtering criteria to arrive at the prescription test list 430. FIG. 5 illustrates a logic flow 500 that may be implemented by the generator 1222 to apply the smart group approach. In some examples, the logic flow 500 may be implemented in the logic flow 2000 at block 2130. As depicted, the logic flow 500 may begin at block 510. At block 510 “filter out over the counter prescriptions from the prescription test list,” the generator 1222 may filter out over the counter (OTC) prescriptions. Continuing to block 520 “filter out duplicates from the prescription test list,” the generator 1222 may filter out duplicates prescriptions. Continuing to block 530 “filter out non-Rx products from the prescription test list,” the generator 1222 may filter out “non-Rx products (e.g., products which pertain to the pharmaceutical segment but are not drugs per se, such as baby diapers, bandages, or the like).

Statistical Approach

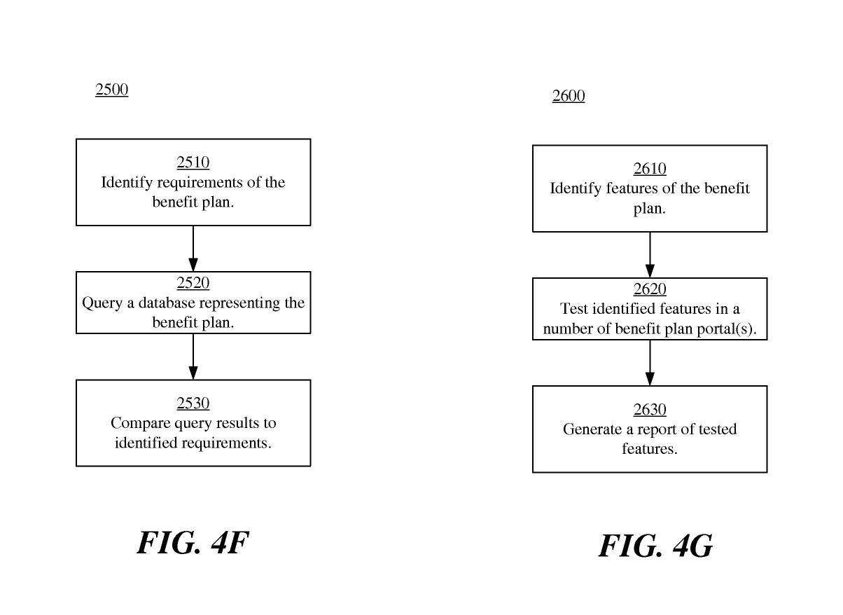

With the statistical approach, the generator 1222 derives the prescription test list 430 based on application of orthogonal array testing (OATS) to the drug list specified in the specification 410. FIG. 6 illustrates a logic flow 600 that may be implemented by the generator 1222 to apply the statistical approach. In some examples, the logic flow 600 may be implemented in the logic flow 2000 at block 2130. As depicted, the logic flow 600 may begin at block 610. At block 610 “identify OATS parameters,” the generator 1222 may identify a number of OATS parameters and the complete set values that these parameters might take up. For example, in some embodiments, OATS parameters may include brand indicator, drug code, multi source, original, single source, generic and OTC.

Continuing to block 620 “derive all permutations of the OATS parameters,” the generator 1222, derives all the permutation (e.g., combinations) of the OATS parameters.

Continuing to block 630 “remove overlapping test cases from the prescription test list based on the permutations of OATS parameters,” the generator 1222 removes redundant test cases from the prescription test list 430.

Most Used Drug Approach

With the most used drug approach, the generator 1222 may generate the prescription test list 430 from historical data of prescription drug usage. For example, the generator 1222 may generate the prescription test list 430 based on historical claims for prescriptions drug coverage made under a plan, made to an insurer, based on industry-wide prescription claims, or the like. Furthermore, the historical prescription data may be analyzed based on various limits to determine the prescription test list 430.

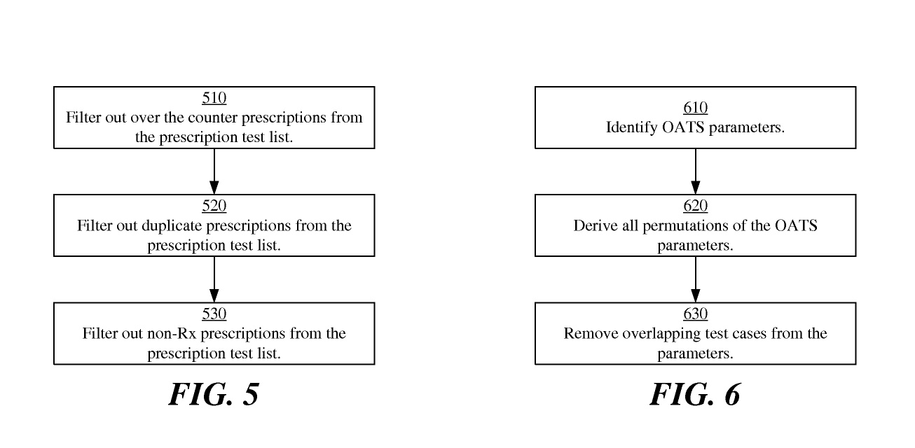

FIG. 7 illustrates a logic flow 700 that may be implemented by the generator 1222 to apply the most used drugs approach. In some examples, the logic flow 700 may be implemented in the logic flow 2000 at block 2130. As depicted, the logic flow 700 may begin at block 710. At block 710 “receive historical data for a particular time period,” the generator 1222 may receive historical prescription drug data corresponding to a particular time period. In some examples, the historical data may be limited to the past three month, the past six month, the past year, or the like.

Continuing to block 720 “identify popular drugs from the historical data” the generator 1222 may identify the “most used” or most popular drugs from the received historical data. For example, the more popular drugs (e.g., prescribed more than a specified number of times, the ‘x’ most commonly prescribed drugs, the top ‘x’ percentage of most commonly prescribed drugs, or the like, where ‘x’ is a specified value) may be selected for inclusion in the prescription test list 430 at block 720.

Closed Formulary Approach

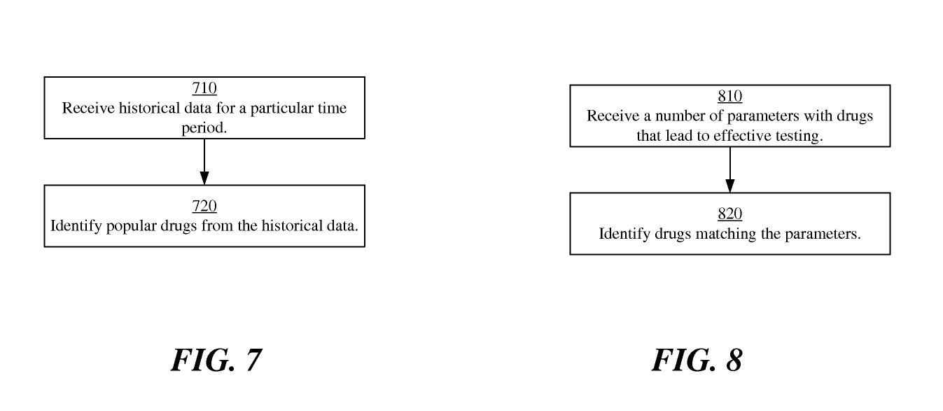

As noted above, the closed formulary approach is applicable only to closed formularies and plans employing closed formulary coverage. In general, this approach identifies the prescription test list 430 from the specification 410. FIG. 8 illustrates a logic flow 800 that may be implemented by the generator 1222 to apply the closed formulary approach. In some examples, the logic flow 800 may be implemented in the logic flow 2000 at block 2130. As depicted, the logic flow 800 may begin at block 810. At block 810 “identify a number of parameters associated with drugs that lead to effective drug testing,” the generator 1222 may identify one or more parameters that are invariably associated with drugs that may lead to effective drug testing. With some examples, the parameters, which may be identified, could include Formulary, Health Care Reform (HRM), Specialty Guideline Management, General Step Therapy Plan (GSTP), Specialty Preferred Drug Plan Design (PDPD), Utilization Management and Formulary Exception. In some examples, the generator 1222 may analyze the specification 410 to identify these parameters. In some examples, the parameters may be specified by a user, and received by the generator 1222.

Continuing to block 820 “identify drugs matching the parameters,” the generator 1222 may identify those drugs listed in the specification 410 that match the parameters and include those drugs in the prescription test list 430.

### Test Designing

In general, the “test designing” portion 2200 includes operations to generate a benefit matrix (e.g., matrix 440) and to generate a number of hypothetical claims (e.g., test claims 450) that can be used to test the benefit plan. As depicted in FIG. 4C, the test designing logic flow 2200 begins at block 2210. Accordingly, the logic flow 2000 may continue from block 2130 to block 2210.

At block 2210 “generate a benefit matrix,” the benefit matrix generator 1223 may generate the benefit matrix 440 from the specification 410. As noted above, the benefit matrix 440 is a consolidated document cataloging all requirements from the specification 410. For example, the matrix 440 may catalog requirements from a client requirement document (CRD), a network information (NIF) document, a clinical plan management (CPM) document, a utilization management records document, and various addendum, or the like. In some examples, the matrix 440 may be a spreadsheet. In some examples, the matrix 440 may be stored in a database (not shown). In some examples, the matrix 440 may be an xml file.

A particular advantage to the present disclosure is the benefit matrix 440. In particular, the benefit matrix 440 provides for the correct capturing of client (e.g., insurer, benefit plan administrator, or the like) intent in a single place. This facilitates traceability, ensures comprehensive test coverage, simplifies the reviewing and signing off by key parties, and serves as the input to generate test scenarios from.

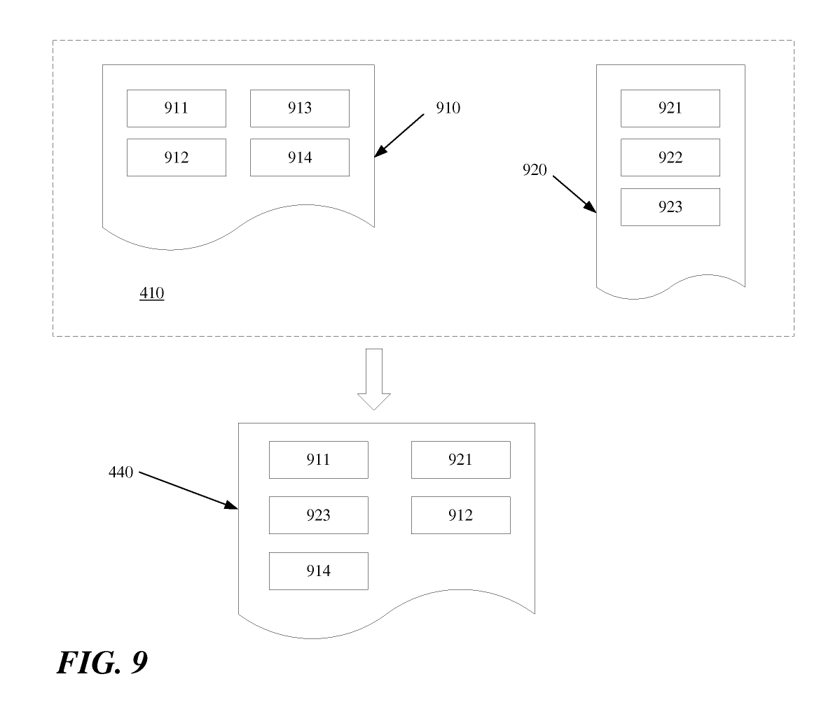

As noted above, the specification 410 typically comprises multiple different documents, which each list various requirements of the benefit plan. FIG. 9 illustrates an example specification 410, which includes documents 910 and 920 and an example benefit matrix 440. As depicted, the document 910 includes requirements 911, 912, 913, and 914. Additionally, the document 920 includes requirements 921, 922, and 923. In generating the benefit matrix 440, some or all of the requirements from the specification 410 (e.g., requirements 911, 912, 913, 914, 921, 922, and/or 923) are mapped into the benefit matrix 440. As can be seen, the benefit matrix includes requirements 911, 912, 914, 921, and 923.

It is to be appreciated, that the example depicted in FIG. 9 is quite simplistic and in practice, the specification 410 may include many more documents and requirements than shown. However, for clarity of presentation, only a few requirements are shown. Furthermore, in some examples, all requirements listed in the specification 410 may be mapped into the benefit testing matrix.

Continuing to block 2220 “generate a number of test claims from the benefit matrix,” the test case generator 1224 may generate the test claims 450 from the benefit matrix 440. In general, the test claims 450 list a number of hypothetical claim scenarios that cover common areas under the benefit plan. In general, the test case generator 1224 generates a number of test cases, and for each test case, may annotate the test case to indicate which area of the benefit plan is being tested and/or what type of results should be expected.

It is to be appreciated, that the generator 1224 may output the test claims 450 in a format usable by a claims processing system (e.g., the server 200, another claim processing system (not shown), or the like). For example, with some embodiments, the test claims 450 may be in a spreadsheet format (e.g., CSV file format, or the like).

In some examples, the generator 1224 may further “tag” each of the hypothetical claims in the test claims 450 and the corresponding sections of the benefit matrix 440 from which the claims correspond. More specifically, tags may be appended to the test claims to enable traceability back to the benefit matrix 440 and even the specification 410 to ensure that requirements are not “lost” (e.g., not tested as desired).

### Test Execution

In general, the “test execution” portion 2300 includes operations to adjudicate hypothetical claims (e.g., the test claims 450). As depicted in FIG. 4D, the “test execution” logic flow 2300 begins at block 2310. Accordingly, the logic flow 2000 may continue from block 2220 to block 2310.

At block 2310 “receive a number of test claims,” the server 200 receives the test claims 450. Continuing to block 2320 “validate the members corresponding to the test claims,” the member validator 2221 validates the members of the hypothetical claims. In particular, the validator 2221 validates the members of the benefit plan and maps them to the test scenarios received. An advantage to the block 2320 is that it replicates the member eligibility information in an actual benefits testing environment. Said differently, it ensures a virtual testing on members that is close to a real-time adjudication process.

Continuing to block 2330 “adjudicate the test claims,” the claim adjudication engine 2222 adjudicates the test claims 450. In particular, the engine 2222 is configured to test each unique benefit plan design based on processing the test claims 450.

As will be appreciated, during the test execution process 2300, issues may arise. For example, the test plan may include an invalid or expired drug in a test scenario, or a benefit plan may not be attached to a group. The process 2300 may include block 2340 to identify such issues and “raise” the issues to an appropriate entity. This may be facilitated with the authorization module described in greater detail below. Accordingly, the processes 2300 may continue to block 2340 “identify any issues with the testing process,” the engine may pass one or more error codes, flags, indicators, or the like to identify the issue.

Continuing to block 2350 “updated test claims received?” the server 200 may receive updated test claims 450. In particular, it may be advantageous to have the process 2300 halt (e.g., for a set period of time, until manually restarted, or the like) between block 2340 and 2350 to provide time for the identified issues to be resolved. If updated test claims are received, the process 2300 may return to block 2310 to retest the test claims 450. If no updated test claims were received (e.g., no errors were identified, no fixes were made, or the like) the process may continue to block 2360 “generate results,” the results generator 2223 may generate the test results 460. In particular, the generator 2223 may generate a file that details how each hypothetical claim was processed in light of benefit plan.

### Test Reporting

In general, the “test reporting” portion 2400 includes operations to generate test reports (e.g., the test report 470). As depicted in FIG. 4E, the test reporting portion 2400 begins at block 2410. Accordingly, the logic flow 2000 may continue from block 2360 to block 2410.

At block 2410 “receive test results 460,” the benefit plan testing device 100 receives the test results 460 from the server 200. Continuing to block 2420 “generate test reports,” the test reporter 1225 may generate the test report 470 corresponding to the test results 460. In some examples, the test report 470 may be formatted as specified by a client (e.g., insurer, benefit plan administrator, or the like). In general, however, the reports will indicate the various items tested (e.g., member demographics, drugs, plan requirements, or the like) and corresponding results of the plan.

Continuing to block 2420 “publish the test results 470,” the publication and approval module 1226 may publish or provide (e.g., via email, cloud storage service, shared document service, or the like) the test report 470 to one or more parties (e.g., stakeholders in the testing process, client contacts, managers, or the like).

Furthermore, as noted above, reports, updates, errors, or other status information may be communicated to one or more interested parties during the testing process. The publication and approval module 1226 may be configured to provide these updates. Furthermore, the publication and approval module 1226 may be configured to halt or pause the testing process until authorization or approval of the status updates is received. For example, in the test planning logic flow, the publication and authorization module 1226 may be configured to provide the test strategy 420 to specified parties and condition continuing from the test planning logic flow 2100 to the test designing logic flow 2200 on receipt of approval from the specified parties.

### Query Testing

As indicated above, with some embodiments, the benefit testing process 2000 may optionally include the query testing logic flow 2500. In some examples, the query testing logic flow 2500 may run in parallel to one or more of the logic flows 2100-2400. In particular, with some examples, the logic flows 2300 and 2500 may run in parallel with each other.

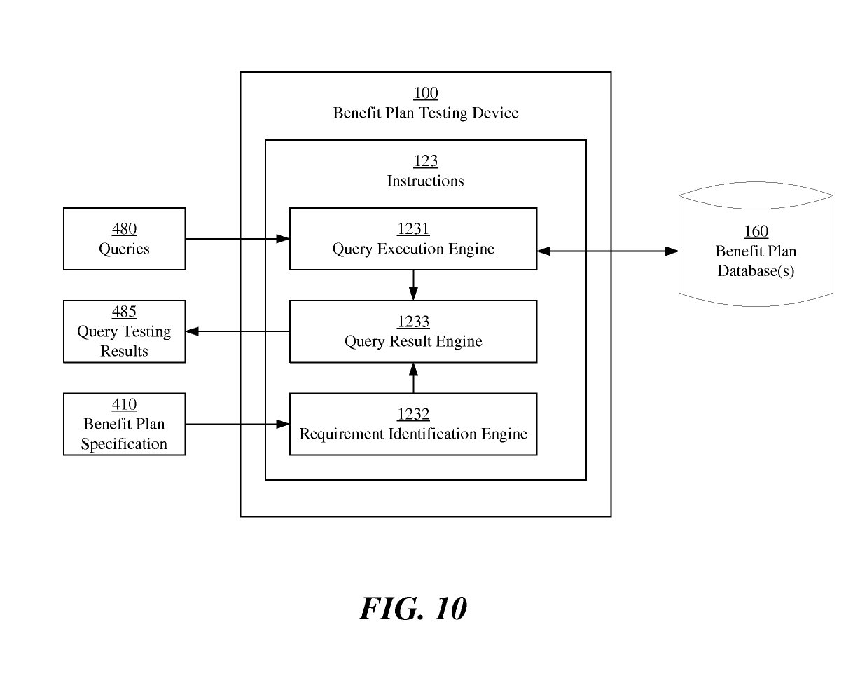

In general, the query testing logic flow 2500 may be executed to determine whether the various databases (refer to FIG. 10) that correspond to and/or define the benefit plan specification 410 are configured correctly. FIG. 10 depicts aspects of the operation of the benefit plan testing device 100 when configured to conduct query testing. In such embodiments, the storage 120 may include instructions 123. The instructions 123 may be executed by the processor component 110 to execute the query testing logic flow 2500. The instructions 123 may include a query execution engine 1231, a requirement identification engine 1232, and a query result engine 1233. FIG. 10 will be referred to in describing the query testing logic flow 2500 in greater detail.

Turning more specifically to FIG. 4F, the query testing logic flow 2500 may begin at block 2510 “identify requirements of the benefit plan” the requirement identification engine 1232 may identify various requirements (e.g., co-pay amounts, age based restrictions on prescriptions, or the like) from the benefit plan specification 410. Continuing to block 2520 “query a database representing the benefit plan” the query execution engine 1231 may query (e.g., SQL queries, XML queries, or the like) a benefit plan database 160. It is to be appreciated that the database 160 may be implemented as multiple databases. However, for convenience, only a single database is depicted. In particular, the query execution engine 1231 may execute queries 480 on the database 160. In general, the queries 480 are representative of the information containing in the benefit plan specification 410. More specifically, the queries 480 include queries that “test” or retrieve information from the database 160 indicative of the various portions, information, requirements, and/or definitions of the benefit plan being tested and contained in the benefit plan specification 410.

The logic flow 2500 may continue to block 2530 “compare query results to the identified requirements” the query result engine 1233 may compare the requirements identified from the benefit plan specification 410 to the results of the queries executed on the database 160. The query result engine 1233 may generate query results 485, which may include indications of discrepancies between the requirements (e.g., obtained at block 2510) and the query results (e.g., obtained at block 2520).

### Integration Testing

As indicated above, with some embodiments, the benefit testing process 2000 may optionally include the integration testing logic flow 2600. In some examples, the integration testing logic flow 2600 may run in parallel to one or more of the logic flows 2100-2500. In particular, with some examples, the logic flows 2300 and 2500 may run in parallel with each other.

In general, the integration testing logic flow 2600 may be implemented to identify integration issues between various applications that are impacted due to benefit changes. In particular, the integration testing logic flow 2600 may be implemented to test various online access portals, such as, for example, online validation of claims, online validation of deductibles & maximum out of pocket (MOOP) accumulations for consumer directed healthcare, or the like.

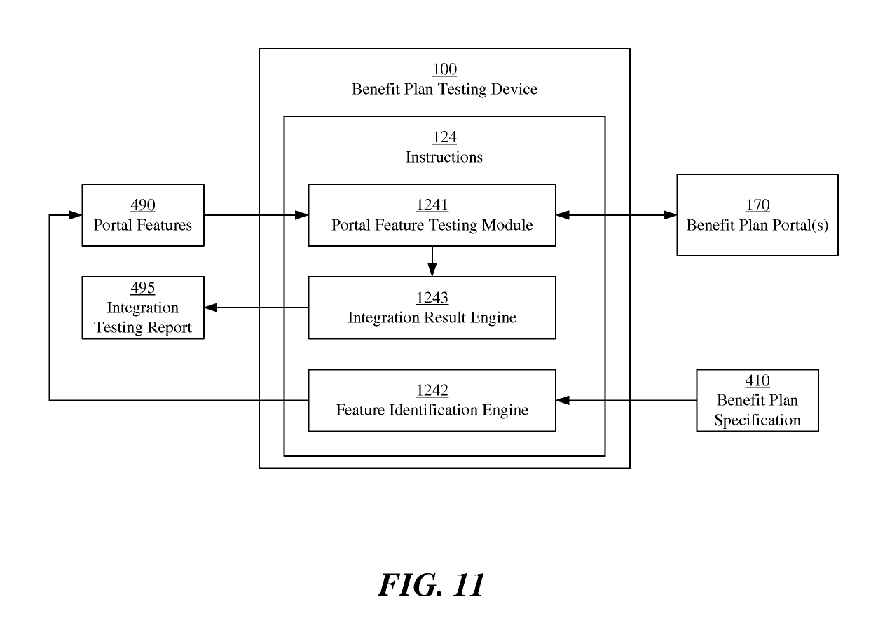

FIG. 11 depicts aspects of the operation of the benefit plan testing device 100 when configured to conduct integration testing. In such embodiments, the storage 120 may include instructions 124. The instructions 124 may be executed by the processor component 110 to execute the integration testing logic flow 2500 to test one or more deployed features (referred to as “portals 170”) of the benefit plan. It is to be appreciated, that the portal(s) 170 can be a variety of different deployments related to the benefit plan, such as, for example without limitation, a member account portal, an online pharmacy refill portal, a voice accessed prescription refill system, or the like. The instructions 124 may include a portal feature testing module 1241, a feature identification engine 1242, and an integration testing result engine 1243. FIG. 11 will be referred to in describing the integration testing logic flow 2600 in greater detail.

Turning more specifically to FIG. 4G, the integration testing logic flow 2600 may begin at block 2610 “identify features of the benefit plan” the feature identification engine 1242 may identify portal features 490 (e.g., online refill ordering, voice prescription fulfillment status system, or the like) from the benefit plan specification 410.

Continuing to block 2620 “test identified features in a number of portal(s)” the portal feature testing module 1241 may test the portal features 490 as deployed in a number of benefit plan portal(s) 170. For example, the portal feature testing module 1241 may validate a member account portal to ensure that ordering a replacement benefit plan ID card operates as intended, an account balance is correctly reported, or the like. As another example, the portal feature testing module 1241 may validate that an interactive voice response system allows prescription refill ordering, correctly reports the status of a prescription under fulfillment (e.g., whether it is ready for pickup, etc.,) or the like.

Continuing to block 2630 “generate a report of the tested features” the integration results engine 1243 may generate an integration testing report 495. The integration testing report may list the various features tested, the results of accessing the features on the benefit plan portal(s) 170, and/or any discrepancies with the expected output of a particular feature and the actual output when the feature is tested.

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

While certain embodiments of the disclosure have been described herein, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

1. A method implemented by a benefit testing system, the method comprising:
receiving a benefit plan specification, the benefit plan specification including a plurality of documents including indications of requirements of a benefit plan;
consolidating the benefit plan specification into a benefit matrix;
generating a set of test claims based in part on the benefit matrix; and
adjudicating the set of test claims under the benefit plan.

2. The method of claim 1, wherein the set of test claims includes at least a first hypothetical test claims, the first hypothetical test claim including an indication of a member, the step for adjudicating the set of test claims comprising validating the member is a member of the benefit plan.

3. The method of claim 2, wherein the first hypothetical claim includes an indication of a prescription filled for the member, the step for adjudicating the set of test claims further comprising determining whether the prescription is covered under the benefit plan.

4. The method of claim 2, the method further comprising generating a prescription test list, the prescription test list including indications of a plurality of prescriptions covered under the benefit plan.

5. The method of claim 4, wherein the step for adjudicating the set of test claims further comprises determining whether each prescription of the plurality of prescriptions is covered under the plan for the member.

6. The method of claim 1, further comprising generating a test strategy based at least in part on the benefit plan specification.

7. The method of claim 4, wherein the test strategy comprises at least a first milestone, the method further comprising providing a report to one or more parties on a status of the benefit testing processes at the first milestone.

8. A method implemented by a benefit testing system, the method comprising:
receiving a benefit plan specification, the benefit plan specification including a plurality of documents including indications of requirements of a benefit plan;
generating a prescription test list including an indication of a plurality of prescriptions;
consolidating the benefit plan specification into a benefit matrix;
generating a set of test claims based in part on the benefit matrix and the prescription test list; and
adjudicating the set of test claims under the benefit plan.

9. The method of claim 8, wherein the set of test claims includes at least a first hypothetical test claims, the first hypothetical test claim including an indication of a member, the step for adjudicating the set of test claims comprising validating the member is a member of the benefit plan.

10. The method of claim 9, wherein the first hypothetical claim includes an indication of a prescription filled for the member, the step for adjudicating the set of test claims further comprising determining whether the prescription is covered under the benefit plan.

11. The method of claim 8, wherein the step for generating the prescription test lists includes:
receiving a covered prescriptions lists, the covered prescription list including an indication of all prescriptions covered under the benefit plan;
filtering out over the counter prescriptions from the covered prescription list;
filtering out duplicate prescriptions from the covered prescription list; and
filtering out non-prescription products from the covered prescription list.

12. The method of claim 8, wherein the step for generating the prescription test lists includes generating the prescription test list based at least in part on an orthogonal array testing scheme (OATS).

13. The method of claim 12, wherein the OATS scheme comprises:
identifying a plurality of OATS parameters;
deriving a plurality of permutations of the plurality of OATS parameters; and
removing overlapping prescriptions from a list of covered prescriptions of the benefit plan based at least in part on the plurality of permutations.

14. The method of claim 8, wherein the step for generating the prescription test lists includes:
receiving historical prescriptions data, the historical prescription data including an indication of a plurality of prescriptions for a specified period of time; and
identifying a subset of the plurality of prescriptions based on a popularity threshold.

15. At least one machine-readable storage medium comprising instructions that when executed by a computing device, cause the computing device to:
receive a benefit plan specification, the benefit plan specification including a plurality of documents including indications of requirements of a benefit plan;
consolidate the benefit plan specification into a benefit matrix;
generate a set of test claims based in part on the benefit matrix; and
adjudicate the set of test claims under the benefit plan.

16. The at least one machine-readable storage medium comprising of claim 15, wherein the set of test claims includes at least a first hypothetical test claims, the first hypothetical test claim including an indication of a member, the machine-readable storage medium further comprising instructions that when executed by the computing device, cause the computing device to validate the member is a member of the benefit plan.

17. The at least one machine-readable storage medium comprising of claim 16, wherein the first hypothetical claim includes an indication of a prescription filled for the member, the machine-readable storage medium further comprising instructions that when executed by the computing device, cause the computing device to determine whether the prescription is covered under the benefit plan.

18. The at least one machine-readable storage medium comprising of claim 16, the machine-readable storage medium further comprising instructions that when executed by the computing device, cause the computing device to generate a prescription test list, the prescription test list including indications of a plurality of prescriptions covered under the benefit plan.

19. The at least one machine-readable storage medium comprising of claim 18, the machine-readable storage medium further comprising instructions that when executed by the computing device, cause the computing device to determine whether each prescription of the plurality of prescriptions is covered under the plan for the member.
